(19) United States
(12) Patent Application Publication
(10) Pub. No.: US 2023/0211537 A1
(43) Pub. Date: Jul. 6, 2023

(54) METHOD FOR MANUFACTURING AN LFT EXTRUSION MEMBER

(71) Applicant: NAN YA PLASTICS CORPORATION, Taipei (TW)

(72) Inventors: TE-CHAO LIAO, TAIPEI (TW); HAN-CHING HSU, TAIPEI (TW); CHUN-LAI CHEN, TAIPEI (TW)

(21) Appl. No.: 18/119,933

(22) Filed: Mar. 10, 2023

Related U.S. Application Data
(63) Continuation-in-part of application No. 16/679,452, filed on Nov. 11, 2019.

(30) Foreign Application Priority Data
Jan. 30, 2019 (TW) 108103609

(51) Int. Cl. B29C 48/65; B29C 48/00; B29C 48/395; B29C 48/655

(52) U.S. Cl. CPC B29C 48/65; B29C 48/022; B29C 48/397; B29C 48/655; B29K 2101/12

(57) ABSTRACT

An extruder and a long fiber thermoplastic (LFT) extrusion member manufactured thereby, and the extruder uses the LFT as a raw material to produce LFT extrusion members such as LFT sheets, pipes and profiles by a continuous extrusion molding process. The structural improvement of the extruder screw, including the screw body having three different thread groove deep sections, in sequence, a feed section, a compression section and a metering section, so that the LFT extrusion member produced by the extruder has high strength, high stiffness, high dimensional stability, low warpage and resistance to creep.

### CROSS-REFERENCE TO RELATED PATENT APPLICATION

This application is a continuation-in-part application of the U.S. application Ser. No. 16/679,452, filed on Nov. 11, 2019, and entitled “EXTRUDER AND LFT EXTRUSION MEMBER MANUFACTURED THEREBY” now pending, the entire disclosures of which are incorporated herein by reference.

### FIELD OF THE DISCLOSURE

The present disclosure relates to an extrusion member of a long fiber thermoplastics, and more particularly to a long fiber thermoplastics (LFT) produced by a continuous pultrusion process, and an extruder using the same.

### BACKGROUND OF THE DISCLOSURE

Long fiber thermoplastics (LFT), also known as long-fiber thermoplastics, are thermoplastic resins made by granulating fibers and thermoplastic resin substrates containing glass and carbon fibers and having a length of 6-25 mm, and is suitable for thermoplastic resins such as polypropylene (PP), polyamide (PA6, PA66), polybutylene terephthalate (PBT) or polyphenylene sulfide (PPS).

Long fiber thermoplastics (LFT) has outstanding features such as light weight, high strength, high stiffness, high dimensional stability, low warpage and resistance to creep. Tensile and impact strength highlights the strength of long fiber thermoplastics (LFT) and make up for the shortcoming of the strength of short fiber composites (SFT).

In related art, sheets, tubes or profiled products of long fiber thermoplastics are processed by injection molding and sheet molding compounds, even though LFT products are processed with continuous pultrusion, the structure of the screw of a single screw extruder need to be improved. For the sheet molding compound processing, the molten mixture is subjected to thermoplastic solidification and molding. The sheet molding products are need produced for multiple times, and the size of each molding product is single. For the injection molding processing, the fluidity of the raw materials is fast, and is not convenient to produce LFT sheets, tubes or profiled products.

### SUMMARY OF THE DISCLOSURE

In response to the above-referenced technical inadequacies, the present disclosure provides an extruder including a screw allowing an LFT extrusion member to be produced by continuous pultrusion process, the screw having following features:

(a) a total length of the screw is L and a diameter is D, and a L/D ratio is between 20 to 26;
(b) a shaft of the screw includes three sections having different thread groove depths, which are sequentially a feed section, a compression section and a metering section. A length of the feed section is L1, a length of the compression section is L2, a length of the metering section is L3, and the screw satisfying the following condition:

### 1) L1+L2+L3=L;

2) a length of the feed section (L1) is 0.40-0.50 times the total length (L) of the screw, preferably 0.40 times of the total length (L) of the screw, a thread groove depth of the feed section is d1, in which 4 mm≤d1≤7 mm;
3) a length of the metering section (L3) is 0.10-0.20 times the total length (L) of the screw, preferably 0.20 times of the total length (L) of the screw, a thread groove depth of the metering section is d3;
4) a compression ratio of the screw is d1/d3, and a ratio of d1/d3 is between 2.0 and 4.0, preferably 2.0-2.5; and
5) a length of the compression section (L2) is 0.30-0.40 times the total length (L) of the screw, preferably 0.40 times of the total length (L) of the screw, a thread groove depth of the compression section is d2, in which d3≤d2≤d1, and preferably d3<d2<d1.

The present disclosure uses the extruder from a continuous extrusion molding process to heat the long fiber thermoplastics into a molten state, and then continuously extrudes the molten plastic from a die head. After vacuum calibrating and cooling, the molten plastic is pulled by a tractor to form a continuous product.

The single screw extruder processing conditions are: a temperature of the first zone is 180-260° C., a temperature of the second zone is 200-260° C., a temperature of the third zone is 210-285° C., a temperature of the fourth zone is 220-290° C., a temperature of the die head is 240-310° C., and a rotation speed of the screw is 5-50 rpm.

A draw speed is controlled at 0.3-2.0 m/min.

In one embodiment, the temperature of the feed section of the screw spans the first zone and the second zone, the temperature of the compression section of the screw spans the second zone and the third zone, and the temperature of the metering section of the screw is located in the fourth zone.

In one aspect, the present disclosure provides a LFT extrusion member produced by a continuous pultrusion process. Long fiber thermoplastics (LFT) is used as raw materials, and is adjusted according to product requirements and manufacturing method parameters. The raw material of the LFT extrusion member includes 1 to 90% by weight of a thermoplastic resin and 10 to 99% by weight of long fiber thermoplastic masterbatch, preferably 33.3 to 75% by weight of thermoplastic resin and 25 to 67.7% by weight of the long fiber thermoplastic masterbatch. The thermoplastic resin is selected from one or any combination of a polypropylene resin, a polyamide, and the long fiber thermoplastic masterbatch has glass fiber or carbon fiber having a length of 6 to 25 mm.

The long-fiber thermoplastics (LFT) raw materials used in the present disclosure, according to the common knowledge of those in the art, may be added with other functional additives, so that the LFT extrusion member produced by the continuous pultrusion process has additional functionality. The additive is selected from one or more of an antioxidant, a lubricant, a weathering agent, and a colorant.

The beneficial effect of the present disclosure is that, the LFT profile extrusion member produced by continuous extrusion molding process has the advantages of light weight, high strength, high rigidity and high dimensional stability.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of an LFT profile extrusion member production apparatus used in the present disclosure.

FIG. 2 is an enlarged view of an improved screw structure of the continuous pultrusion extruder in the LFT profile extrusion member production apparatus of FIG. 1.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

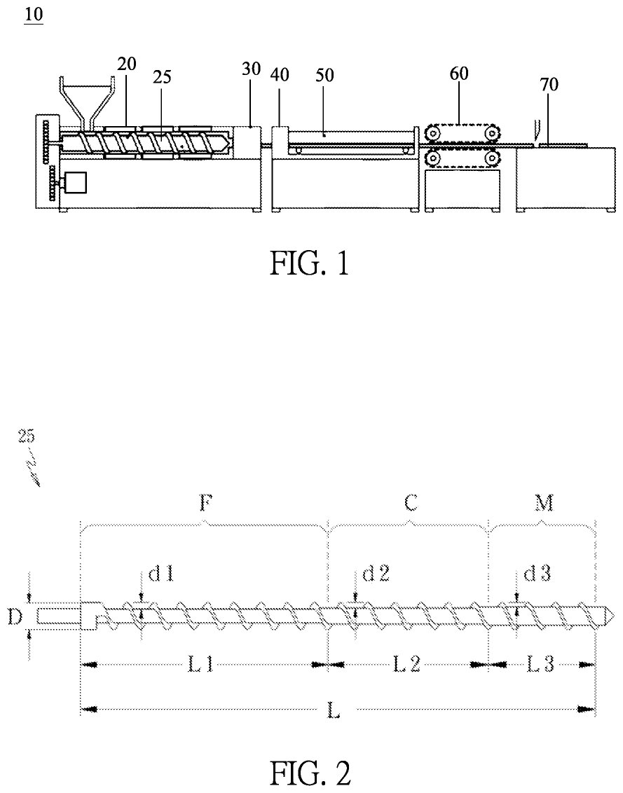

As shown in FIG. 1, the LFT profile extrusion member production apparatus 10 used in the present disclosure includes a single screw extruder 20, an extrusion die head 30, a vacuum calibrating die 40, a cooling water tank 50, a tractor 60 and a cutting machine 70. An LFT profile extrusion member production process includes: long fiber thermoplastics (LFT) being heated into a molten state by the single screw extruder 20, the molten LFT plastic being extruded from extrusion type head 30 continuously, formed and cooled by vacuum calibrating die 40 (can be round, flat, square or shaped), and then completely cooled by water cooling or air cooling through the cooling water tank 50, and a formed product being continuously drawn by the tractor 60, and cut into sizes by the cutting machine 70.

As shown in FIG. 2, the present disclosure provides an extruder 20 having a screw 25 and producing an LFT extrusion member by continuous pultrusion process including following conditions:

(a) a total length of the screw 25 is L and a diameter is D, and a L/D ratio is between 20 to 26;

(b) a shaft of the screw includes three sections having different thread groove depths, which are sequentially a feed section F, a compression section C and a metering section M. A length of the feed section F is L1, a length of the compression section C is L2, a length of the metering section M is L3, and the screw 25 satisfied the following condition:

1) L1+L2+L3=L;

2) a length of the feed section F (L1) is 0.40-0.50 times the total length (L) of the screw 25, preferably 0.40 times of the total length (L) of the screw 25, a thread groove depth of the feed section is d1, and 4 mm≤d1≤7 mm.

3) a length of the metering section M (L3) is 0.10-0.20 times the total length (L) of the screw 25, preferably 0.20 times of the total length (L) of the screw 25, a thread groove depth of the metering section M is d3.

4) a compression ratio CR of the screw 25 is d1/d3, and a ratio of d1/d3 is between 2.0 and 4.0, preferably 2.0-2.5; and

5) a length of the compression section C (L2) is 0.30-0.40 times the total length (L) of the screw 25, preferably 0.40 times of the total length (L) of the screw 25, a thread groove depth of the compression section C is d2, and d3 d2≤d1, preferably d3<d2<d1.

The raw material of the LFT extrusion member includes 1 to 90% by weight of a thermoplastic resin and 10 to 99% by weight of long fiber thermoplastic masterbatch, preferably 33.3 to 75% by weight of thermoplastic resin and 25 to 67.7% by weight of the long fiber thermoplastic masterbatch. The thermoplastic resin is selected from one or any combination of a polypropylene resin, a polyamide, and the long fiber thermoplastic masterbatch has glass fiber or carbon fiber having a length of 6 to 25 mm.

The processing conditions of the single screw extruder 20 are: five heating temperature zones are divided, long fiber thermoplastics (LFT) is gradually heated into a molten state, a temperature of the first zone is 180-260° C., a temperature of the second zone is 200-260° C., a temperature of the third zone is 210-285° C., a temperature of the fourth zone is 220-290° C., a temperature of the die head is 240-310° C. and speed of the screw 25 is 5-50 rpm. A draw speed is controlled at 0.3-2.0 m/min.

In one embodiment, the temperature of the feed section F (L1) of the screw spans the first zone and the second zone, the temperature of the compression section C (L2) of the screw spans the second zone and the third zone, and the temperature of the metering section M (L3) of the screw is located in the fourth zone shown in Table 1.

Raw materials of the long-fiber thermoplastics (LFT) used in the present disclosure may be added with other functional additives according to person having ordinary skill in the art, so that the LFT extrusion member produced by continuous pultrusion has additional functionality, and the additive is selected from one or more of an antioxidant, a lubricant, a weathering agent, and a colorant.

The following embodiments are only given to illustrate the contents and the achievable effects of the present disclosure, and the present disclosure is not limited thereto. The physical properties of the embodiments and comparative examples are evaluated by the following methods:

1. Specific Gravity: determined by ASTM-D792.

2. Tensile strength (MPa): determined by ASTM D638.

3. Bending strength (MPa): determined by ASTM D 790.

4. Flexural modulus (MPa): determined by ASTM D 790.

5. Izod impact strength (kg-cm/cm): determined by ASTM D 256.

6. Load test (kgf): flexural failure tests with a span of 70 cm.

### Embodiment 1

Long fiber thermoplastics (LFT) contains 33.3% by weight of thermoplastic resin and 66.7% by weight of long fiber thermoplastic masterbatch (containing 60% glass fiber). As shown in FIG. 1 and FIG. 2, an LFT profile extrusion member production apparatus 10 having an extrusion amount of 25-50 kg/hr is used, and an LFT flat sheet is produced by a continuous pultrusion processing method.

A screw 25 of a single screw extruder 20 has the following structural features:

1) A screw length L is 1,690 mm; a screw diameter D is 65 mm; an L/D ratio is 26;

2) A shaft of the screw 25 is divided into three sections, a length of a feed section (L1) is 0.40 times the total length (L) of the screw, a length L2 of a compression section C is 0.40 times the screw length L, and a length of a metering section (L3) is 0.20 times the total length (L) of the screw; and

3) a thread groove depth d1 of the feed section is 7; a thread groove depth d3 of the metering section C is 3; the screw 25 of compression ratio (d1/d3) is 2.33.

The processing conditions of the single screw extruder 20 are: five heating temperature zones are divided, the temperature of the first zone is 210° C., the temperature of the third zone and the fourth zone is 220° C., the temperature of the fifth zone is the temperature of the die head 220° C., speed of the screw 25 is 8 rpm, and a draw speed is controlled at 0.71 m/min.

The physical properties of the LFT plate prepared are tested, and the test results are shown in Table 2.

### Embodiment 2

Except that the extrusion die head 30 of the single screw extruder 20 is changed to being a circular die, the raw material formulation and its preparation method are the same as those in Embodiment 1, and are used to obtain an LFT circular tube having an outer diameter of Ø 34 mm×a thickness of 2.0 mm.

The physical properties of the LFT circular tube prepared are tested. The test results are shown in Table 3.

### Embodiment 3

Except that the extrusion die head 30 of the single screw extruder 20 is changed to being a square tube die, and five heating temperature zones are divided, the temperature of the first zone being 190° C., the temperature of the second zone being 210° C., the temperature of the third zone being 220° C., the temperature of the fourth zone being 225° C., the temperature of the fifth zone being the temperature of the square tube die 240° C., rotation speed of the screw 25 being 8 rpm, and a draw speed being controlled at 0.56 m/min, the raw material formulation and its preparation method are the same as those in Embodiment 1, and are used to obtain an LFT square tube having a length of 30 mm×a width of 30 mm×a thickness of 2.0 mm.

The physical properties of the LFT circular tube prepared are tested. The test results are shown in Table 3.

### Embodiment 4

The extrusion die head 30 of the single screw extruder 20 is a tube die, and five heating temperature zones are divided, the temperature of the first zone being 190° C., the temperature of the second zone being 210° C., the temperature of the third zone being 225° C., the temperature of the fourth zone being 220° C., the temperature of the fifth zone being the temperature of the tube die 245° C., rotation speed of the screw 25 being 8 rpm, and a draw speed being controlled at 0.56 m/min, the raw material formulation and its preparation method are the same as those in Embodiment 1, and are used to obtain an LFT square tube having a length of 30 mm×a width of 30 mm×a thickness of 2.0 mm.

The physical properties of the LFT plate prepared are tested, and the test results are shown in Table 3.

### Comparative Example 1

The samples are generally commercially available rigid PVC plates, and the physical properties of the test samples are shown in Table 3.

### Comparative Example 2

The raw material formulation and its preparation method same as in embodiment 1, but an LFT plate having a width of 50 mm×a thickness of 3.0 mm is produced by injection molding.

The physical properties of the LFT plate prepared are tested, and the test results are shown in Table 3.

### Comparative Example 3

The sample is a commercially available rigid PVC circular tube with an outer diameter of Ø 34 mm×a thickness of 2.0 mm. The physical properties of the test samples are shown in Table 3.

The physical properties of the LFT plate material obtained in embodiment 1 are compared with the commercially available rigid PVC plate of Comparative Example 1 and the LFT plate (abbreviated as the injection plate material) of Comparative Example 2 by injection molding, impact strength of the LFT plate of the embodiment 1 is 3 times that of a PVC board and 1.2 times that of injection board, the tensile strength and flexural strength of the LFT plate of the Embodiment 1 are also better than those of the PVC board, and the density of the LFT plate of the embodiment 1 is smaller than that of the PVC board. With light weight, high strength and high rigidity, the LFT plate of the Embodiment 1 can replace the PVC board and injection sheet.

According to the data in Table 2, LFT sheets, tubes and profiles produced by continuous extrusion molding in the present disclosure, not only effectively improves the load strength of the LFT profile extrusion member, but also has the competitiveness provided by their light weight.

In the manufacturing process, the present invention is different from the injection molding process. For injection molding, it requires high fluidity of raw materials, however, for the present invention (extrusion molding), it requires low fluidity of raw materials. Extrusion molding is more suitable for manufacturing an LFT production.

TABLE 1
Relationship between the screw sections and the heating zone

| Section | Feed section | Compression section | metering section |
|---|---|---|---|
| The proportion | 0.4 | 0.4 | 0.2 |
| of the whole | | | |
| screw length | | | |

| | Heating temperature zone | | | |
|---|---|---|---|---|
| | First zone | Second zone | Third zone | Fourth zone |
| Temperature | 180-260° C. | 200-260° C. | 210-285° C. | 220-290° C. |
| range | | | | |

TABLE 2
Comparison of physical properties of PVC
and PP long fiber injection and extrusion

| | | | | Comparative |
|---|---|---|---|---|
| | | embodi- | Comparative | example 2 |
| | | ment 1 | example 1 | PP long fiber |
| Term | Unit | LFT sheet | PVC plate | shot flat plate |
| Glass fiber content | % | 60 | 0 | 40 |
| Specific gravity | g/cm³ | 1.16 | 1.387 | 1.22 |
| Tensile strength | MPa | 95 | 53 | 120 |
| Bending strength | MPa | 176 | 84 | 180 |
| Bending modulus | MPa | 8,370 | 3,239 | 7,800 |
| Izod impact strength | kg- | 30 | 11 | 25 |
| | cm/cm | | | |

TABLE 3
Load test of PP long fiber circular tube, PP
long fiber square tube and PVC circular tube

| Term | | flexural failure (kgf) | Span (mm) |
|---|---|---|---|
| LFT circular tube | 1 | 41.92 | 700.00 |
| | 2 | 42.55 | 700.00 |
| | 3 | 42.15 | 700.00 |
| | average | 42.21 | 700.00 |
| LFT square tube | 1 | 152.65 | 700.00 |
| | 2 | 156.78 | 700.00 |
| | 3 | 158.62 | 700.00 |
| | average | 156.02 | 700.00 |
| PVC circular tube | 1 | 21.62 | 700.00 |
| | 2 | 22.35 | 700.00 |
| | 3 | 22.15 | 700.00 |
| | average | 22.04 | 700.00 |

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a long fiber thermoplastic (LFT) extrusion member by an extruder, comprising:
preparing a raw material which includes 33.3 to 75% by weight of a thermoplastic resin and 25 to 67.7% by weight of long fiber thermoplastic masterbatch;
melting the raw material at a temperature of a first zone ranging from 180 to 260° C., a temperature of a second zone ranging from 200 to 260° C., a temperature of a third zone ranging from 210 to 285° C., a temperature of a fourth zone ranging from 220 to 290° C., and a temperature of a die head ranging from 240 to 310° C.;
extruding the raw material by an extruder with a draw speed from 0.3 m/min to 2.0 m/min to form the LFT extrusion member through continuous pultrusion process, wherein the extruder includes a screw and extrusion conditions includes:
wherein a total length of the screw is L and a diameter is D, and an L/D ratio is between 20 to 26;
wherein a shaft of the screw includes three sections having different thread groove depths, which are sequentially a feed section, a compression section and a metering section, wherein a length of the feed section is L1, a length of the compression section is L2, a length of the metering section is L3, wherein L1+L2+L3=L;
wherein a length of the feed section is 0.40-0.50 times the total length of the screw, a length of the compression section is 0.30-0.40 times the total length of the screw, and a length of the metering section is 0.10-0.20 times the total length of the screw;
wherein a thread groove depth of the feed section is d1, a thread groove depth of the compression section is d2, and a thread groove depth of the metering section is d3, wherein 4 mm≤d1≤7 mm, and d3<d2<d1;
wherein a compression ratio of the screw is d1/d3, and a ratio of d1/d3 is between 2.0 and 4.0; and
wherein a temperature of the feed section of the screw spans the first zone and the second zone, a temperature of the compression section of the screw spans the second zone and the third zone, and a temperature of the metering section of the screw is located in the fourth zone.

2. The method according to claim 1, wherein a rotation speed of the screw of the extruder ranges from 5 rpm to 50 rpm.

3. The method according to claim 1, wherein the thermoplastic resin is at least one selected from a polypropylene resin, a polyamide, and a polyphenylene sulfide, and the long fiber thermoplastic masterbatch has glass fiber or carbon fiber having a length of 6 to 25 mm.

4. The method according to claim 1, wherein the thermoplastic resin further includes an additive, and the additive is selected from one or more of an antioxidant, a lubricant, a weathering agent, and a colorant.

5. The method according to claim 1, wherein the LFT extrusion member is an LFT flat plate, an LFT circular tube or an LFT square tube.

6. The method according to claim 1, further comprising: cutting the LFT extrusion member into sizes by a cutting machine.
